(19) United States
(12) Patent Application Publication
(10) Pub. No.: US 2009/0249224 A1
(43) Pub. Date: Oct. 1, 2009

(54) SIMULTANEOUS COLLABORATIVE REVIEW OF A DOCUMENT

(75) Inventors: Tristan A. Davis, Redmond, WA (US); E. Mark Sunderland, Seattle, WA (US); Ethan Bernstein, Mercer Island, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/059,766

(22) Filed: Mar. 31, 2008

(51) Int. Cl. G06F 3/048

(52) U.S. Cl. 715/753

(57) ABSTRACT

A document is simultaneously opened by different clients for a collaborative review of the document. Each of the clients may make comments to the document at the same while the document is also being edited. Comments made on the document by one client are automatically synchronized with the other clients that are simultaneously accessing the document.

### BACKGROUND

It is common for a collaborative review process to be used in the development of word processing documents. In one scenario, a user authors a document and then emails copies of the documents to reviewers. These reviewers then make comments on an independent copy of the document. Once each reviewer has completed the review process, they send back a commented version of the document to the author. The author then “merges” these comments into a single document. The author may need to resolve conflicting comments by resending changes to reviewers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A document is simultaneously opened by different clients for a collaborative review of the document. Each of the clients may make comments to the document at the same time. Comments made on the document by one client are automatically synchronized with the other clients that are simultaneously accessing the document.

### BRIEF DESCRIPTION OF THE DRAWINGS

FIG. 1 illustrates an exemplary computing device;

FIG. 2 shows a collaborative review system;

FIG. 3 illustrates an exemplary document with associated comments; and

FIG. 4 shows an illustrative process for collaboratively reviewing a document.

### DETAILED DESCRIPTION

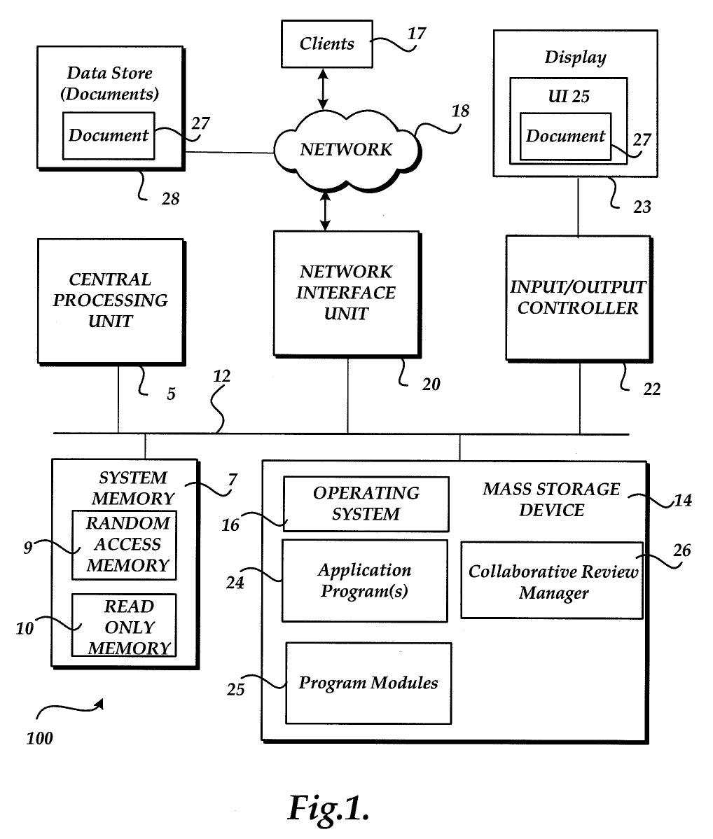

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop or mobile computer and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application program(s) 24, other program modules 25, and collaborative review manager 26 which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen 23, a printer, or other type of output device.

As mentioned briefly above, a number of program modules and data files may be stored in the mass storage device 14 and RAM 9 of the computer 100, including an operating system 16 suitable for controlling the operation of a networked personal computer, such as the WINDOWS® VISTA® operating system from MICROSOFT CORPORATION of Redmond, Wash. The mass storage device 14 and RAM 9 may also store one or more program modules. In particular, the mass storage device 14 and the RAM 9 may store one or more application programs 24 that are configured to interact with a document, such as document 27 stored in networked data store 28. For example, application program 24 may be a rich client application such as MICROSOFT WORD® from MICROSOFT CORPORATION of Redmond, Wash. Application program 24 may also be a thin client that does not include the full set of functionality of the rich client application. For example, a thin client could be implemented within a browser program that includes functionality to display content of the document and allows comments to be made on the document.

Application program 24 utilizes collaborative review manager 26 to allow simultaneous collaborative review of a document. Generally, collaborative review manager 26 assists in synchronizing comments made by different clients 17 on document 27. Comments made by one user are integrated into document 27 such that each user who has document 27 open for commenting/editing can see comments that are made by the other users. According to one embodiment, the document to review is stored in a data store 28 that may be accessed by different users who are located at different locations. For example, the document may be stored in a document library that is accessible on the network. Each reviewer can open the document from the central repository to provide comments on the document. The reviewers may access the document at the same or different times, without need to ensure that only one person has the document open at a time. In this way, a person may be making changes to the document while others are commenting the document. Additional details regarding the collaborative review manager will be provided below.

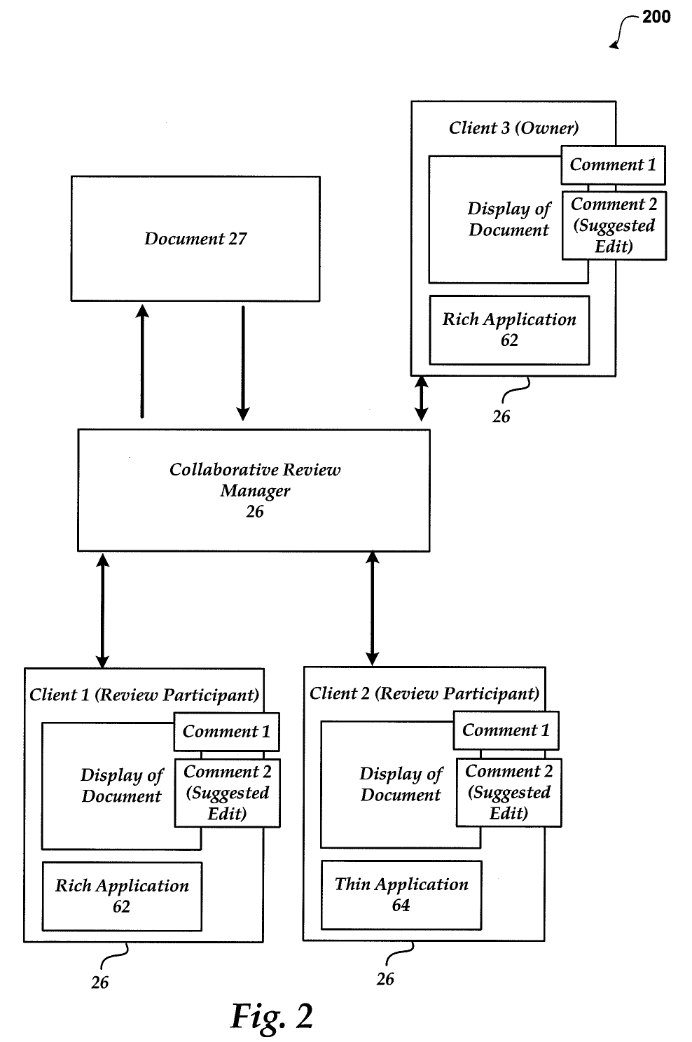

FIG. 2 shows a system 200 for collaboratively reviewing a document. As illustrated, system 200 includes clients 1-3, collaborative review manager 26, display 23 and document 27. Each of the clients include an application to interact with the documents and make comments on the document.

As illustrated, Clients 1 and 3 include a rich application 62 that provides editing and commenting ability on document 27. The rich client application may be a word processing application that created document 27, or some other application that provides a rich set of functionality for editing and changing structure of document 27. For example, the rich application may be a program from the MICROSOFT OFFICE suite of applications, such as MICROSOFT WORD. Client 2 is illustrated with a thin application 64 that provides a limited set of functionality (as compared to rich client application 62) for making comments on document 27. Thin application 64 could be an application that provides the ability to display document 27 and the ability to make comments on the document. For example, a thin application may be a simple web interface that allows a user to make comments. The thin client UI does not require the functionality of the rich application, such that the review and commenting process of the document is not exclusive to only users of a particular version of the client software application.

Once a document, such as document 27, is created, reviewers are invited to make comments to the document. The reviewers may be invited automatically using functionality that is associated with an application, such as a document collaboration application, or the reviewers may be invited by some other method. For example, the reviewers may be emailed a link to the document, indicating that the document is ready for commenting. According to one embodiment, the document is placed into a data store 28 such that it may be accessed by other users on the network. For example, the document 27 may be placed in a shared location on a network.

The collaborating users (i.e. Clients 1-3) may then simultaneously open the document and make comments. As illustrated, some users simultaneously access the document using the same or different rich application, while other users access the document using a thin client. Each user may insert comments at the same time into the document. According to one embodiment, a user makes a comment on content of the document by selecting the content of the document and then inserting the text of the comment into a text box. Other methods of inserting the comment text may also be used. For example, a user could select the content then right click and enter the comment text. The comment is associated with the selected content. According to one embodiment, content of the document is selectable in sections. For example, a user may select a paragraph of the document to comment on. In addition to making comments, one or more of the clients may be designated as an author or owner that has editing privileges with the document that allow structural changes to be made to the document. For example, a user may add content, delete content, move content, and the like. According to one embodiment, one client is designated as the author or owner of document 27. When an author has the document open for editing, other users are prevented from editing the content currently being edited and are limited to making comments on the content. In this way, the comments from multiple authors can be synchronized between multiple copies of the file in real-time, enabling each author to see any comments entered by other authors while they have a copy of the document open for editing.

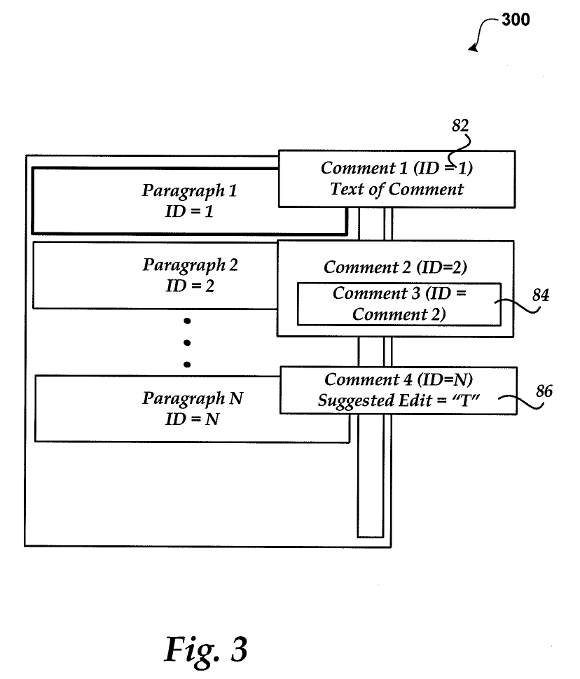

The comments made by each client (i.e. Clients 1-3) are synchronized among the different applications that are currently accessing the document. According to one embodiment, the comments made on a client are synchronized with the version of the document at the data store 28 upon a save event. Generally, synchronizing the comments includes writing the comments to document 27. Since the comments made to the file are non-conflicting comments from different clients may be written into the document at the same time. Other ways of synchronizing the comments may also be used. For example, comments to the document could be synchronized upon the occurrence of some other event (i.e. period of time expiring, user moves to another paragraph, and the like). Once synchronized, the comments made by the other clients are shown in the other applications on the other client devices. Since the comments are provided to each client that currently has the document open, the reviewers see the comments from the other reviewers while they are still reviewing the document. In this way, users can respond to the other comments made on the document. For example, a reviewer may comment on a comment instead of commenting on the document itself (See FIG. 3 and related discussion).

If a client (i.e. an author of the document) is editing the document and removes a paragraph for which a comment is made then the comment becomes an orphaned comment. An orphaned comment is a comment that is no longer associated with a section of the document. In one embodiment, orphaned comments are displayed near the location of the removed document content. Alternatively, the orphaned comments are removed from the document and a message is displayed to the user indicating that the content the paragraph was made has been removed and the comment is no longer valid.

A client may also decide to enter a suggested edit that if accepted by the author would automatically be incorporated into the document. According to one embodiment, a suggested edit is treated as a type of comment (See FIG. 3 and related discussion). Alternatively, a suggested edit could be treated independently.

According to one embodiment, a client can also create a copy of the document and synchronize the comments with the shared copy instead of directly accessing the shared document. For example, a reviewer could make comments to a copy of the document that is stored locally, and then upon a commit then the change is synchronized with the shared copy.

FIG. 3 illustrates an example of a client interface that includes a display of an exemplary document including comments.

According to one embodiment, when content is hovered over such as paragraph 1, the content is highlighted and an input text box may be displayed to receive a comment on the highlighted portion. Similarly, a previously made comment may be selected to allow a reviewer to comment on the comment. As illustrated, document content is divided into discrete sections. For example, the document content is divided into sections based on words, lines, sentences, paragraphs, pages, and the like. As illustrated, the document content sections are defined by the paragraphs of the document. According to one embodiment, each section within the document is tagged with a unique identifier such that comments may be easily attached to the appropriate section. Associating a unique identifier with each section helps to ensure that even when the section changes location within the document, the associated comments on that section are attached to the correct section. For simplicity of illustration in FIG. 3, paragraph 1 has an ID of 1; paragraph 2 has an ID of 2 and paragraph N has an ID of N. The unique identifier may any identifier that uniquely identifies each section. For example, the unique identifier could be a Globally Unique Identifier (GUID).

Comments made on the document by the clients are associated with the section to which the comment pertains. As illustrated, Comment 1 is associated with paragraph 1. As can be seen, the ID (82) of comment 1 is set to the ID of paragraph 1. Similarly comment 2 is associated with paragraph 2 and comment 4 is associated with paragraph N.

As discussed briefly above, a comment may also be made on a previous comment. In the current example, comment 3 is a comment that is made on comment 2. For example, a comment on a previous comment may be made when a user has selected a comment of the document and then adds content. According to one embodiment, the comment is associated with the parent comment by setting the comments ID to be that of the comment to which it is associated. Other methods may also be used to associate the comment with the previous comment. For example, each comment made on a previous comment could be nested appropriately in a tree structure.

A comment may also be identified as a suggested edit. In the current example, comment 4 is identified as a suggested edit. A suggested edit is very similar to a comment, but the suggested edit provides a way to incorporate the comment into the document's content. In the current example, a suggested edit is identified by a True/False setting (i.e. Suggested Edit=“T” or “F”). An application may provide an option that allows the document author to accept/reject suggested edits. When the author accepts the suggested edit, then the comment is automatically incorporated into the content of the document. When the author rejects the suggested edit then the content of the suggested edit is not incorporated into the document. Some thin clients may not include this functionality in which case the suggested edit is treated as a comment.

According to one embodiment, each comment is stored as a data structure that includes information associating the comment with the section of the document to which the comment was made; whether the comment is a suggested edit; and the text of the comment. In one embodiment, comments are stored using XML. For instance, the XML tag indicates that the content is a comment that includes an attribute that identifies the content that it is associated with. Other tags may also be included, for example, a task comment could be used. A task comment could be used to indicate that the comment is a task to be associated with the creation of the document. The suggested edit may also be identified by a flag within a comment tag. Other attributes may also be included in a comment, including a time the comment is made, a name of who made the client, an ID of the comment, and the like

According to another embodiment, an edit marker may also be associated with each paragraph such that a determination may be made as to whether a comment that is made applies to the current state of the document. For example, when a first client accesses the document, a paragraph may have an edit ID of 2. the first client adds a comment and when the comment is moved to the central data store it is determined that the edit ID of the same paragraph is now 3 that indicates the paragraph has been edited. When the edit IDs are different a warning message may be provided along with a copy of the changed paragraph.

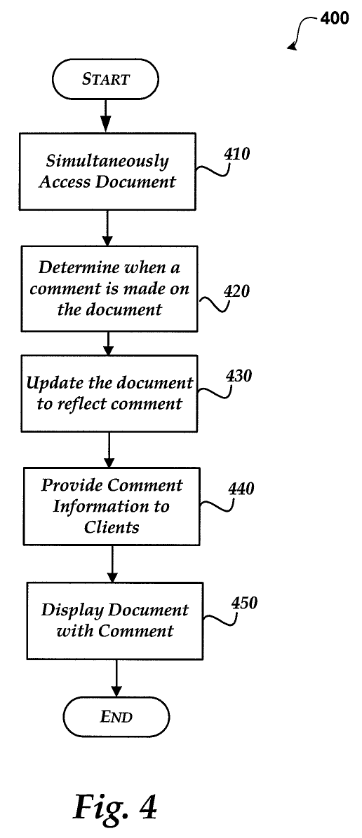

Referring now to FIG. 4, an illustrative process 400 for collaboratively reviewing a document will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, the process flows to operation 410, where a client accesses a document that is simultaneously being accessed by at least one other client. The document is opened such that each client may write to the document to incorporate comments that are made on the document.

Moving to operation 420, a determination is made as to when a comment is made on the document. According to one embodiment, a comment is made on a document after the comment is committed to the document by the occurrence of a predefined event. For example, the client saves the document. Other events may also be used (i.e. period of time expiring, user moves to another paragraph, and the like).

Flowing to operation 430, the shared document is updated to reflect the comment. According to one embodiment, the comment is written to the document that is maintained by a networked data store that is shared by the clients accessing the document.

Transitioning to operation 440, the comment made by one client is provided to the other clients. This may include the client accessing the updated document and/or sending each client comment information relating to the comment. For example, each client could include the comment and a section of the document to which the comment pertains.

Moving to operation 450, each client displays the document with the incorporated comment. The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for collaboratively reviewing a document, comprising:
simultaneously accessing a document from multiple clients; wherein accessing the document includes accessing the document using an application that allows comments to be made on the document;
determining when a comment is made on the document from at least one of the clients;
updating the document to reflect the comment; and
providing the comment and information that associates the comment with a location in the document to each of the clients that is simultaneously accessing the document such that the display of the document on each of the clients includes the comment.

2. The method of claim 1, wherein simultaneously accessing the document from the multiple clients includes accessing the document using a thin client and accessing the document from a client application; wherein the thin client includes a subset of the functionality compared to the client application.

3. The method of claim 1, wherein content of the document is divided into sections; wherein each section is associated with a unique identifier; and wherein determining when the comment is made comprises identifying the section of the document which was commented and associating the comment with the unique identifier of the determined section of the document.

4. The method of claim 1, wherein the document remains unlocked when the document is simultaneously accessed from the multiple clients such that any of the multiple clients may write to the document.

5. The method of claim 1, wherein the sections of the document are identified by one of the following delimiters: a word; a line; a paragraphs; and a sentence.

6. The method of claim 1, wherein determining when the comment is made further comprises determining when the comment is a suggested edit to the document; and when the comment is a suggested edit then identifying the comment as a suggested edit.

7. The method of claim 1, further comprising determining when a previous comment that is associated with the document is selected and associating the comment with the previous comment instead of associating the comment with content of the document.

8. The method of claim 1, wherein at least one of the clients performs edits of the content of the document that affects a structure of the document while the other clients are accessing the documents and at least one of the clients is making a comment on the content of the document.

9. A computer-readable storage medium having computer-executable instructions for making comments on a document from different clients, comprising:
simultaneously opening a document from the different clients; wherein opening the document includes opening the document in an unlocked state using one or more applications that allows comments to be made on the document;
wherein the unlocked state of the document allows any of the different clients to write to the document;
determining when a comment is made on the document from at least one of the different clients;
updating the document to reflect the comment; and
providing the comment to each of the different clients; wherein the comment is stored within a data structure that includes information that associates the comment with a location in the document.

10. The computer-readable storage medium of claim 9, wherein simultaneously accessing the document from the different clients includes allowing one of the different clients to be an owner of the document; wherein the owner is allowed to make structural changes to the document while the other different clients are making comments on the document.

11. The computer-readable storage medium of claim 9, wherein content of the document is divided into sections; wherein each section is associated with a unique identifier; and wherein determining when the comment is made comprises identifying the section which was commented and associating the comment with the unique identifier of the determined section of the document.

12. The computer-readable storage medium of claim 9, further comprising determining when a section no longer exists to which a comment is made and when the section does not exist providing a display of the comment at a location near the location of the missing content.

13. The computer-readable storage medium of claim 9, wherein the sections of the document correspond to each paragraph of the document.

14. The computer-readable storage medium of claim 9, wherein determining when the comment is made further comprises determining when the comment is a suggested edit to the document; and when the comment is a suggested edit then identifying the comment as a suggested edit and wherein at least some of the clients allow the suggested edit to be automatically incorporated into the content of the document.

15. The computer-readable storage medium of claim 9, further comprising determining when a previous comment that is associated with the document is selected and associating the comment with the previous comment instead of associating the comment with content of the document.

16. A system for making comments on a document from different clients, comprising:
a data store that is configured to store a document that is accessible from the different clients;
a first client that comprises:
a network connection that is configured to connect to the data store;
a processor and a computer-readable medium;
an operating environment stored on the computer-readable medium and executing on the processor; and
an application that is configured to open the document from the data store; wherein the document is also opened by other clients at the same time the application opens the document; wherein the application is configured to make comments on the document; wherein opening the document includes opening the document in an unlocked state; wherein the unlocked state of the document allows any of the different clients to write to the document; and
a collaborative manager operating under the control of the operating environment and operative to:
determine when a comment is made on the document;
update the document to reflect the comment; and
provide the comment to the other clients that have opened the document; wherein the comment is stored within a data structure that includes information that associates the comment with a location in the document.

17. The system of claim 16, wherein content of the document is divided into sections; wherein each section is associated with a unique identifier; and wherein determining when the comment is made comprises identifying the section which was commented and associating the comment with the unique identifier of the determined section of the document.

18. The system of claim 16, wherein the sections of the document correspond to each paragraph of the document.

19. The system of claim 16, wherein determining when the comment is made further comprises determining when the comment is a suggested edit to the document; and when the comment is a suggested edit then identifying the comment as a suggested edit and wherein at least some of the clients allow the suggested edit to be automatically incorporated into the content of the document.

20. The computer-readable storage medium of claim 16, further comprising determining when a previous comment that is associated with the document is selected and associating the comment with the previous comment instead of associating the comment with content of the document.
